(19) United States
(12) Patent Application Publication
(10) Pub. No.: US 2023/0205779 A1
(43) Pub. Date: Jun. 29, 2023

(54) SYSTEM AND METHOD FOR GENERATING A SCIENTIFIC REPORT BY EXTRACTING RELEVANT CONTENT FROM SEARCH RESULTS

(71) Applicant: Genpro Research Inc., Waltham, MA (US)

(72) Inventors: Kapil M. Khambholja, Vadodara (IN); Anoop P. Ambika, Thiruvananthapuram -16 (IN); Niyas A. Mohammed, Thiruvananthapuram (IN); Praveen Saji, Alleppey (IN); Sruthi Mannambeth, Mamba (IN); Raj K. Prakas, Varkala (IN)

(73) Assignee: Genpro Research Inc., Waltham, MA (US)

(21) Appl. No.: 18/086,246

(22) Filed: Dec. 21, 2022

Related U.S. Application Data
(60) Provisional application No. 63/294,104, filed on Dec. 28, 2021.

(51) Int. Cl. G06F 16/25; G06F 16/248; G06F 16/2457; G06V 30/412; G06F 40/295; G06F 40/169; G06F 40/30; G06F 40/177; G06F 40/174; G06F 40/117; G06F 40/242; G06F 40/205

(52) U.S. Cl. CPC G06F 16/254; G06F 16/248; G06F 16/24578; G06V 30/412; G06F 40/295; G06F 40/169; G06F 40/30; G06F 40/177; G06F 40/174; G06F 40/117; G06F 40/242; G06F 40/205

(57) ABSTRACT

A system and method for generating a scientific report by extracting relevant content from search results in a time-efficient literature screening, authoring, and finalization is described. The system provides an integrated end-to-end workflow covering scientific literature search, filtering, extraction, authoring, and quality control which is enabled using an artificial intelligence model for obtaining the search result including at least one document, determining a subset of document layout regions from a plurality of document layout regions based on at least one context, extracting a text, applying a Natural Language Processing (NLP) technique on the text to extract at least one custom-named entity, and updating the scientific report with at least a part of the extracted text.

### CROSS-REFERENCE TO RELATED APPLICATIONS

This application claims priority to, and the benefit of, co-pending U.S. Provisional Application No. 63/294,104, filed Dec. 28, 2021, for all subject matter common to both applications. The disclosure of said provisional application is hereby incorporated by reference herein in its entirety.

### TECHNICAL FIELD

The present invention relates to a medical and scientific report generation system, and, more particularly, to a system and method for generating a scientific report by extracting relevant content from search results automatically.

### DESCRIPTION OF THE RELATED ART

A scientific report is a document that describes the process, progress, and or results of technical or scientific research or the state of a technical or scientific research problem. It may also include recommendations and conclusions of the research. The scientific reports are generally written with the purpose of peer review and publication. A well-written scientific report explains the scientist's motivation for doing an experiment, the experimental design and execution, and the meaning of the results. Scientific reports are written in a style that is exceedingly clear and concise.

Peer-reviewed scientific publications are the primary method today for disseminating and archiving scientific advances. It is a well-known belief that science grows and advances through a communal collection of knowledge that is constantly being challenged, revised, and expanded. Conventionally, scientists have a strong desire to contribute to the advancement of their field, which is often their primary reason for becoming a scientist. A scientific publication is usually the most straightforward way to make such a contribution, and it is thus highly motivating and satisfying to most scientists. Further, publishing the scientific report may also be beneficial to an author, thus providing a self-interested motivation for writing and publishing a scientific report. Often such scientific reports are also required for many different purposes including but not limited to regulatory requirements, presentation to various scientific organizations, track and document outcomes of interventions and other strategic reasons.

Medical and scientific reports authoring involves manual search, triage, data extraction, authoring, and review as key steps and is often complicated through legacy processes and systems. Researchers and writers may have to deal with data from a variety of database sources while struggling to keep up with multistep, multi-stakeholder processes. Besides core activities of interpretation and analysis, writers inevitably spend a lot of time supporting repetitive tasks which slows down the process and distracts from more important tasks. Searching the database sources and gathering all the relevant documents is a tedious task, which consumes more time to research.

Gathering information from the relevant documents is also a tedious task, as most of the relevant documents may be very long to study, and the documents may include only a few topics that are only related to the researching instances, where the information has to be gathered manually from those topics. Further, the information may be in the texts or in the tables in different sections of the different documents, in different formats, to derive in to the report manually which is computationally complex to analyze the documents and extract information. Currently, the approach for the above-mentioned problem is to extract information with keywords, which is also time-consuming and cumbersome process. Searching the documents based on the keywords-based approach may lead to inaccurate results as the context may be different. If the results are inaccurate, there may be a case of a time lag between the search and the results, analysis of the document, and extracting the information in the report, which also affects the computation time.

However, all of the aforementioned existing solutions have various shortcomings related to the problems associated with the conventional techniques for authoring medical and scientific reports. Therefore, in light of the foregoing discussions, there exists a need to overcome these various shortcomings associated with conventional literature screening, authoring, and finalization techniques.

### SUMMARY

In the view of the foregoing, an embodiment herein provides a method for generating a scientific report by searching a database for one or more documents using an automated computer vision-based detection combined with a Natural Language Processing (NLP) technique. The method includes receiving a user input including at least one of user data, keywords, a context, and search terms using one or more user devices. The method includes providing the user input as a query to the database to obtain a search result that comprises at least one document. The method includes performing the automated computer vision-based detection on the at least one document from the search result to detect a plurality of document layout regions. The method includes obtaining at least one context from the at least one document. The method includes determining a subset of document layout regions from the plurality of document layout regions based on the at least one context. The method includes extracting text from the subset of the document layout regions. The method includes applying a Natural Language Processing (NLP) technique on the text extracted from the subset of the document layout regions to extract at least one custom-named entity based on the at least one context. The method includes updating the scientific report with the at least a part of the text extracted from the subset of the document layout regions that comprises the at least one custom-named entity.

In some embodiments, the subset of document layout regions is determined from the plurality of document layout regions by detecting and annotating at least one structure of the at least one document using the automated computer vision-based detection combined with the NLP technique. The at least one structure includes a text retrieval, a text categorization, a content categorization, an image parsing, or a table detection.

In some embodiments, the text extracted from the subset of document layout regions identifies a meaning of the extracted text by obtaining contextual data or context data of the text, and a hierarchy of the text from the subset of document layout regions. The contextual data or the context data include information about background of the at least one document surrounding the extracted text.

In some embodiments, the method further includes generating a running text based on the at least one custom-named entity in one or more tables of the subset of the document layout regions to extract at least one table by analysing titles, descriptions, co-ordinates, and structure of the one or more tables. The method includes populating the extracted at least one table in the scientific report using the NLP technique.

In some embodiments, the method further includes generating the document score on the one or more documents stored in the database by analysing the user data, the search terms and the document source, search results, subset of documents, and user behaviours comprising click-through rate, recognize rate, rejection rate, reading rate, and additional rate of the one or more documents stored in the database, using a document recommendation algorithm. The document recommendation algorithm includes a Vector Space Model (VSM) to generate the document score. The method includes ranking the one or more documents on the database based on the document score using the AI model. The method includes obtaining the search result including the at least one document based on the ranking using the AI model.

In some embodiments, the method further includes enabling the user to at least one of accept or reject the at least one document in the search result using the one or more user devices, that enables re-generating the document score on the one or more documents in the database using the document recommendation algorithm and re-ranking the one or more documents on the database based on the document score using the AI model.

In some embodiments, the method further includes inputting the extracted text from the subset of the document layout regions and contextual information based on the user input using the AI model, and providing the extracted text and contextual information as a query to the database to obtain a search result that includes at least one document, that enables re-ranking of the one or more documents in the database using the document recommendation algorithm.

In some embodiments, the method further includes determining a location of the at least a part of the text extracted from the subset of the document layout regions in the updated scientific report. The location of the at least a part of the text includes x and y coordinates and page numbers of the at least one document. The method further includes navigating to the at least one document when the scientific report including the at least a part of the text from the at least one document is clicked.

In some embodiments, the method further includes highlighting the extracted at least one custom-named entity based on the at least one context on the subset of the document layout regions using an NLP highlighter framework. The NLP highlighter framework highlights the extracted at least one custom-named entity by analysing Rule-based parsing, Dictionary lookups, POS tagging, and Dependency parsing of the at least one custom-named entity.

In some embodiments, the method further includes automatically populating a reference section on the scientific report by analysing the updated scientific report, and automatically updating the reference section when the scientific report is changed or updated based on the search result.

In some embodiments, the at least one context and the at least one named entity include any of demographics including at least one of age group, gender, race, or ethnicity. The at least one custom-named entity includes severity, prevalence, incidence, country, medical conditions including at least one of unmet needs, or adverse events, intervention including at least one of treatments, therapies or devices, and outcomes.

In some embodiments, the detection of the plurality of document layout regions using the automated computer vision-based detection includes identifying each character from the at least one document from the search result, creating one or more words by analysing the identified characters, separating the one or more words with any of font style, font name and font size, illustrating a rectangle in a first colour for the one or more words in a document layout of a second colour in the text extracted from the subset of the document layout regions, identifying at least one contour region by dilating the document layout of the second colour using at least one parameter, and forming the plurality of document layout regions by analysing the at least one identified contour region. The at least one parameter includes any of word spacing, word height, or font spacing.

In some embodiments, the method further includes detecting a reading order on the at least one document from the search result by computing both horizontal and vertical spaces using the automated computer vision-based detection, and selecting a separator when the horizontal and vertical spaces satisfy one or more conditions.

In some embodiments, the method further includes identifying Participants, Interventions, Comparison, and Outcomes (PICO) on the at least one document using a PICO detection model. The PICO detection model is trained by Medical Information Mart for Intensive Care (MIMIC) dataset and the collected data, thereby identifying the at least one document accurately.

In some embodiments, the method further includes generating a workflow based on the updation of the scientific report using a prisma workflow model, and automatically generating a visual representation of the generated workflow. The prisma workflow model realigns based on changes in the user input.

In some embodiments, the method further includes automatically filtering the at least one document in the search result by identifying the at least one custom-named entity, the extracted text from the subset of the document layout regions and the user behaviours in the at least one document.

In an aspect, a system for generating a scientific report by searching a database for one or more documents using a computer vision-based detection combined with a Natural Language Processing (NLP) technique is provided. The system includes a memory that store one or more instructions, and a processor that executes the one or more instructions. The processor is configured to receive a user input including at least one of user data, keywords, a specific context, and search terms using one or more user devices. The processor is configured to provide the user input as a query to the database to obtain a search result that includes at least one document. The processor is configured to perform the automated computer vision-based detection on the at least one document from the search result to detect a plurality of document layout regions. The processor is configured to obtain at least one context from the at least one document. The processor is configured to determine a subset of document layout regions from the plurality of document layout regions based on the at least one context. The processor is configured to extract text from the subset of the document layout regions. The processor is configured to apply a Natural Language Processing (NLP) technique on the text extracted from the subset of the document layout regions to extract at least one custom-named entity based on the at least one context. The processor is configured to update the scientific report with the at least a part of the text extracted from the subset of the document layout regions that includes the at least one custom-named entity.

In another aspect, one or more non-transitory computer-readable storage mediums storing the one or more sequences of instructions, which when executed by the one or more processors, causes to perform a method for generating a scientific report by searching a database for one or more documents using a computer vision-based detection combined with a Natural Language Processing (NLP) technique is provided. The method includes receiving a user input including at least one of user data, keywords, a context and search terms using one or more user devices. The method includes providing the user input as a query to the database to obtain a search result that comprises at least one document. The method includes performing the automated computer vision-based detection on the at least one document from the search result to detect a plurality of document layout regions. The method includes obtaining at least one context from the at least one document. The method includes determining a subset of document layout regions from the plurality of document layout regions based on the at least one context. The method includes extracting text from the subset of the document layout regions. The method includes applying a Natural Language Processing (NLP) technique on the text extracted from the subset of the document layout regions to extract at least one custom-named entity based on the at least one context. The method includes updating the scientific report with the at least a part of the text extracted from the subset of the document layout regions that includes the at least one custom-named entity.

The method and the system provide a machine-assisted literature generation that produces medical and scientific reports easily. In an example embodiment, with an intuitive end-to-end workflow and artificial intelligence (AI) assisted processes, the machine-assisted literature generation supports a variety of scientific documentation use cases. Modules of the system operating in conjunction with each other provide an end-to-end workflow system for generating the scientific report automatically by automating the tasks of scientific literature search, filtering, extraction, authoring, and quality control that supports continuous learning features which allows the method and the system to evolve based on the user behavior and user feedback from the user.

The system uses a human-in-the-loop (HITL) deep learning approach to develop AI models that may provide document recommendation, layout detection, content extraction, context-sensitive de novo text generation, table extraction, table parsing, table to text conversion along with collaborative authoring and collaborative review. In accordance with one embodiment, the system includes one or more modules that operate in conjunction to provide an end-to-end workflow system for generating the scientific report by automating the tasks of scientific literature search, filtering, extraction, authoring, and quality control that further supports continuous learning features which allows the method and the system to evolve based on the user behavior and user feedback from the user.

In accordance with aspects of the invention, the machine-assisted literature generation platform may receive a customer search string as input and search within the standard document repositories. The standard document repositories may include but are not limited to, Pubmed, Ovid, Embase and Google, and the like. The next step of the search comes when the user accepts or rejects the article based on the relevancy of the publication. The system may use predefined algorithms to rank the one or more documents on the database based on the specific search terms, e.g., Unmet Needs.

In accordance with aspects of the invention, all the data pertinent to the user search string along with the information about the accepted and rejected documents may be stored in the database. In an example embodiment, the document recommendation algorithm can be trained using the data stored in the database so that the search results can be sorted and presented optimally to the user. The document recommendation algorithm may include a rank optimization algorithm based on the user feedback, thereby enabling the user to obtain the search result with the most relevant documents.

In accordance with aspects of the invention, the system includes a document layout detection module that is configured to perform post-processing on the at least one document to remove a header and a footer and determine headings.

The system and method produce medical and scientific reports easily and in the minimum possible time, and support a variety of scientific documentation and use cases. The database is configured to store the various information that may be received, exchanged, generated, or stored for the purposes of literature screening, authoring, and finalization. Based on the information provided by the users through the user devices and information available in the database, the process of producing scientific reports is completed electronically. The system provides an efficient mechanism for literature screening, authoring, and finalization that speeds up the scientific literature creation process by reducing cost and document creation time. The system provides a platform that helps in creating and updating scientific reports easily and quickly.

The document recommendation module significantly reduces the time required for the researcher to choose the relevant document. The processor performs the document layout on the at least one document using the document layout analysis to improve the computation time. The document layout detection understands hierarchy, context, and other meta information related to the plurality of document layout regions, which includes textual content, and properties like coordinates of the document layout region, page numbers, texts, font information, and rotation information, which improves in final authoring with optimized processing time. Absence of the document layout detection may bring much noise in the extracted data.

### BRIEF DESCRIPTION OF THE DRAWINGS

These and other characteristics of the present invention will be more fully understood by reference to the following detailed description in conjunction with the attached drawings, in which:

FIG. 1 illustrates a system view for generating a scientific report by extracting relevant content from search results according to some embodiments herein;

FIG. 2 illustrates a block diagram of the system of FIG. 1 according to some embodiments herein;

FIG. 3A is a block diagram of a search result obtaining module of FIG. 2 according to some embodiments herein;

FIG. 3B is a block diagram of a document layout detection module of FIG. 2 according to some embodiments herein;

FIG. 3C is a block diagram of a text extraction module of FIG. 2 according to some embodiments herein;

FIG. 4A is an exemplary block diagram of the system of FIG. 1 to summarize extracted text as a paragraph according to some embodiments herein;

FIG. 4B is an exemplary block diagram of the system of FIG. 1 to extract at least one table according to some embodiments herein;

FIG. 5 is an exemplary block diagram of the system of FIG. 1 according to some embodiments herein;

FIGS. 6A-6E illustrate exemplary user-interfaces of the system according to some embodiments herein; and

FIG. 7 is a flow diagram illustrating a method for generating a scientific report by extracting relevant content from search results according to some embodiments herein.

### DETAILED DESCRIPTION OF THE DRAWINGS

The present subject matter relates to aspects relating to an integrated platform for supporting medical and scientific report generation.

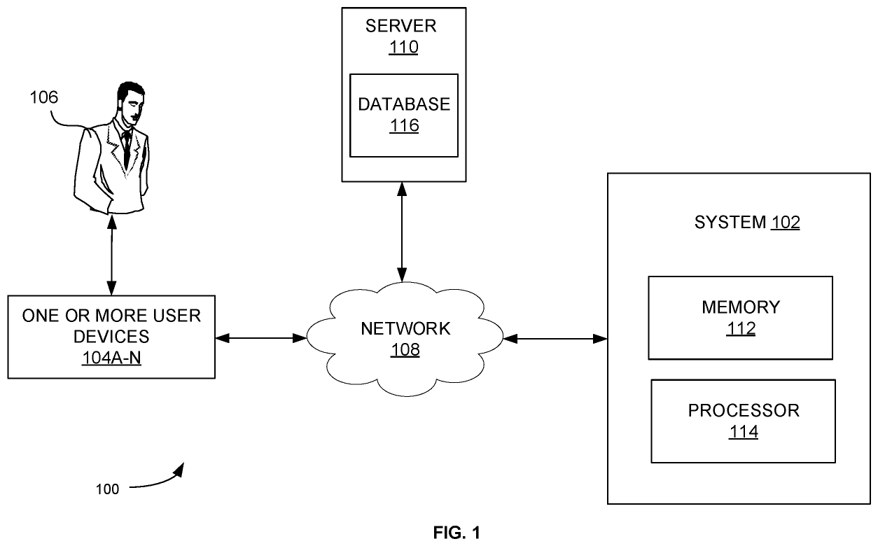

FIG. 1 illustrates a system view 100 for generating a scientific report by extracting relevant content from search results according to some embodiments herein. The system view 100 includes a system 102, one or more user devices 104A-N, a user 106, a network 108, and a server 110. The system 102 may be a server that receives an input and transmits an output based on the requirements of the user 106. The one or more user devices 104A-N are associated with the user 106. In some embodiments, the one or more devices 104A-N include, but not limited to, a tablet, a smartphone, a mobile phone, a laptop, a personal computer, a personal assistant device, and the like. The one or more user devices 104A-N may be configured to receive inputs from the user 106 and communicates the inputs to the system 102. The inputs may be a user input.

The one or more user devices 104A-N may access the system 102 by a locally installed report generation client or plugin, or through browsers. In some embodiments, the one or more user devices 104A-N communicate with the system 102 through the network 108. The network 108 may be a single network or a combination of multiple networks and may use a variety of different communication protocols. The network 108 may be a wireless or a wired network, or a combination thereof. Examples of such individual networks include, but are not limited to, Global System for Mobile Communication (GSM) network, Universal Mobile Telecommunications System (UMTS) network, Personal Communications Service (PC S) network, Time Division Multiple Access (TDMA) network, Code Division Multiple Access (CDMA) network, Next Generation Network (NON), Public Switched Telephone Network (PSTN). In some embodiments, the network 108 includes different network entities, including gateways, and routers.

The system 102 includes a memory 112, and a processor 114. The memory 112 that stores one or more instructions and the processor 114 executes the one or more instructions. The memory 112 may include any computer-readable medium known in the art including, for example, volatile memory (e.g., RAM), and/or non-volatile memory (e.g., EPROM, flash memory, etc.). The memory 112 may also be an external memory unit, such as a flash drive, a compact disk drive, an external hard disk drive, and the like. In some embodiments, the memory 112 includes a database to store one or more documents. In some embodiments, the memory 112 includes one or more internal databases or external databases. The processor 114 may be implemented as microprocessors, microcomputers, microcontrollers, digital signal processors, central processing units, state machines, logic circuitries, and/or any devices that manipulate signals based on operational instructions. The server 110 includes a database 116 that stores information of inputs received, data exchanged, and outputs generated in the system 102. In some embodiments, the server 110 communicates with the system 102 through the network 108. In some embodiments, the system 102 is a part of a hosted service executed on the server 110.

The system 102 receives a request from the user 106 for generating the scientific report, that enables the processor 114 to receive the user input from the user 106 using the one or more user devices 104A-N. In some embodiments, the user input includes at least one of user data, keywords, a context and search terms. The user data may include any of a name, an identification number, or a user specified field, the keywords may include one or more relevant words that the user 106 is interested in, the context may include relevant sentences or relevant lines that the user 106 interested in, and the search terms may include user-specified search terms to search the database 116 for the one or more documents. The processor 114 is configured to provide the user input as a query to the database 116 to obtain a search result that includes at least one document. The database 116 may include one or more documents uploaded by respective persons, sourced documents from referral persons, or websites like Pubmed or Google Scholar. In some embodiments, database 116 includes an internal database and an external database.

The document recommendation algorithm is configured to search and identify the at least one document from the one or more internal databases or external databases using semantic search based on a combination of synonyms, ontologies, dictionaries and word vectors, of the keywords, results in retrieving most relevant documents from distributed document repositories. In some embodiments, the system 102 includes a natural query expansion algorithm for the semantic search. In some embodiments, the system 102 enables the server 110 to store the identified at least one document in the database 116. The processor 114 is configured to perform the automated computer vision-based detection on the at least one document from the search result to detect a plurality of document layout regions. In some embodiments, the plurality of document layout regions includes header, footer, heading titles, and corresponding paragraphs. The processor 114 is configured to obtain at least one context from the at least one document. The at least one content includes information related to the user input.

The processor 114 is configured to determine a subset of document layout regions from the plurality of document layout regions based on the at least one context. In some embodiments, the subset of document layout regions is determined from the plurality of document layout regions by detecting and annotating at least one structure of the at least one document using the automated computer vision-based detection combined with the NLP technique. The at least one structure includes a text retrieval, a text categorization, a content categorization, an image parsing, or a table detection. In some embodiments, the system 102 includes a document layout analysis to detect and annotate the at least one structure of the at least one document. For example, for a pdf document of 1000 pages, where the system 102 performs the document layout analysis to identify where the at least one table is located in the 1000 pages, which results in 15 pages. Then the system 102 may enable table extraction only on the 15 pages to extract the at least one table.

The processor 114 is configured to extract text from the subset of the document layout regions. In some embodiments, the text extracted from the subset of document layout regions identifies the meaning of the extracted text by obtaining contextual data or context data of the text, and a hierarchy of the text from the subset of document layout regions. The contextual data or the context data includes information about background of the at least one document surrounding the extracted text.

The processor 114 is configured to apply a Natural Language Processing (NLP) technique on the text extracted from the subset of the document layout regions to extract at least one custom-named entity based on the at least one context. The processor 114 may enable the NLP technique to highlight the one or more right portions of the text extracted from the subset of the document layout regions. In some embodiments, the system 102 includes an NLP-based highlighter framework that highlights the extracted at least one custom-named entity based on the at least one context on the subset of the document layout regions. The NLP highlighter framework may highlight the extracted at least one custom-named entity by analysing Rule-based parsing, Dictionary lookups, POS tagging, and Dependency parsing of the at least one custom-named entity.

In some embodiments, the at least one context and the at least one named entity includes any of demographics including at least one of age group, gender, race, or ethnicity The at least one custom-named entity includes severity, prevalence, incidence, country, medical conditions including at least one of unmet needs, or adverse events, intervention including at least one of treatments, therapies or devices, and outcomes. The processor 114 is configured to update the scientific report with the at least a part of the text extracted from the subset of the document layout regions that includes the at least one custom-named entity.

In some embodiments, the system 102 enables the server 110 to store the generated scientific report in the database 116. The server 110 may enable interactions with any technical expertise and domain experts for finalizing the generated scientific report. The server 110 also enables modifications and suggestions in the generated scientific report by any of the technical expertise and domain experts, and stores all versions of the generated scientific report in the database 116. The generated scientific report may be displayed on a user interface of the one or more user devices 104A-N. In some embodiments, the generated scientific report can be displayed on the locally installed report generation client or plugin, or through browsers. In some embodiments, the generated scientific report can be downloaded in any of Docx or PDF format.

The server 110 may serve as a repository of electronic, computer-readable information pertaining to inputs fed to the system 102 and/or outputs generated by the system 102 (e.g., data/output generated at each stage of the data processing), specific to the methodology described herein. More specifically, the server 110 stores information being processed at each step of the proposed methodology.

In some embodiments, the system 102 includes one or more data including input data, output data, and other data, and one or more modules that include routines, programs, objects, components, data structures, and the like, which perform particular tasks or implement particular abstract data types. The one or more modules may supplement applications on the system 102, for example, modules of an operating system.

In some embodiments, the processor 114 is configured to automatically summarize the part of the text extracted from the subset of the document layout regions into at least one summarized paragraph in a predetermined word limit without losing scientific context, and automatically identifying and extracting at least one table from the subset of the document layout regions based on the at least one custom-named entity. The predetermined word limit may be 150 words. The processor 114 may update the scientific report with the at least one summarized paragraph and the at least one table.

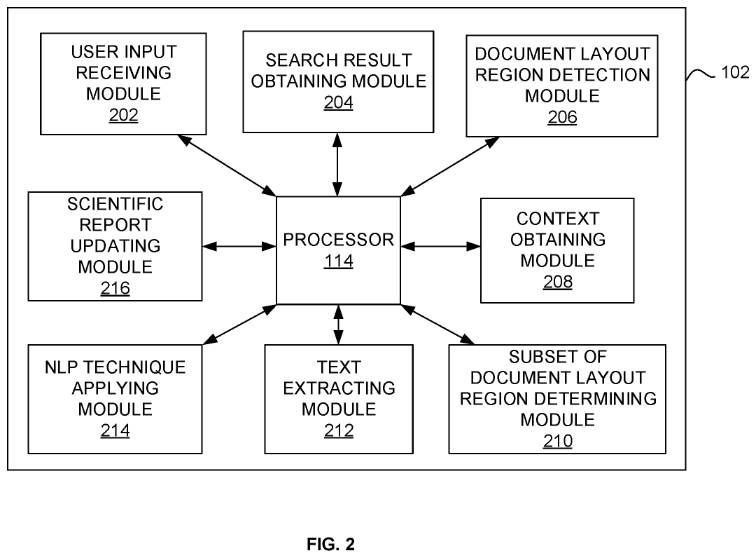

FIG. 2 illustrates a block diagram of the system 102 of FIG. 1 according to some embodiments herein. The system 102 includes a user input receiving module 202, a search result obtaining module 204, a document layout region detection module 206, a context obtaining module 208, a subset of document layout region determining module 210, a text extracting module 212, an NLP technique applying module 214, a scientific report updating module 216, and the processor 114. In some embodiments, the system 102 includes an Artificial Intelligence (AI) model for generating the scientific report by searching the database 116 for the one or more documents using the automated computer vision-based detection combined with the Natural Language Processing (NLP) technique. The user input receiving module 202 is configured to receive the user input from the user 106 using the one or more user devices 104A-N. The user input may be at least one of user data, the keywords, the context, and the search terms related to a specific search topic or title, that the user 106 is interested in.

The search result obtaining module 204 is configured to provide the user input as the query to the database 116 to obtain the search result that includes the at least one document. In some embodiments, the AI model is configured to obtain the search result. In some embodiments, the system 102 includes a document recommendation algorithm that is configured to generate a document score on the one or more documents stored in the database 116 by analyzing the user data, the search terms, the document source, search results, document subsets, and user behaviors including click-through rate, recognize rate, rejection rate, reading rate, and additional rate of the one or more documents stored in the database 116.

The document layout region detection module 206 is configured to detect the plurality of document layout regions by performing the automated computer vision-based detection on the at least one document from the search result. The context obtaining module 208 is configured to obtain the at least one context from the at least one document. The subset of document layout region determining module 210 is configured to determine a subset of document layout regions from the plurality of document layout regions based on the at least one context. The text extracting module 212 is configured to extract text from the subset of the document layout regions.

The NLP technique applying module 214 is configured to apply a Natural Language Processing (NLP) technique on the text extracted from the subset of the document layout regions to extract the at least one custom-named entity based on the at least one context. The NLP technique may include a Named Entity Recognition (NER) model to extract information as the at least one custom-named entity. In some embodiments, the NER model is configured to detect a named entity and the custom-named entity, and categorize the named entity and the custom-named entity, based on the at least one context. In some embodiments, the search string expansion can be done using the NLP technique including inflection, noun chunk, and NER identification, and concept tree expansion. The scientific report updating module 216 is configured to update the scientific report with the at least a part of the text extracted from the subset of the document layout regions that includes the at least one custom-named entity. For example, if the NER model is applied on the text dump of the document will arrive at wrong or noisy data as the entity mentions.

The system 102 may include a user interface module that is configured to generate and display a user interface in the one or more user devices 104A-N, that enables the user 106 to communicate with the system 102. In some embodiments, the user interface couples the one or more user devices 104A-N to the system 102, the server 110 and the system 102, or components of the system 102. The user interface may include a variety of software and hardware interfaces that allow interaction of the system 102 with other communication and computing devices, such as network entities, external repositories, and peripheral devices.

The processor 114 is communicatively connected with the user input receiving module 202, the search result obtaining module 204, the document layout region detection module 206, the context obtaining module 208, the subset of document layout region determining module 210, the text extracting module 212, the NLP technique applying module 214, the scientific report updating module 216 to generate the scientific report.

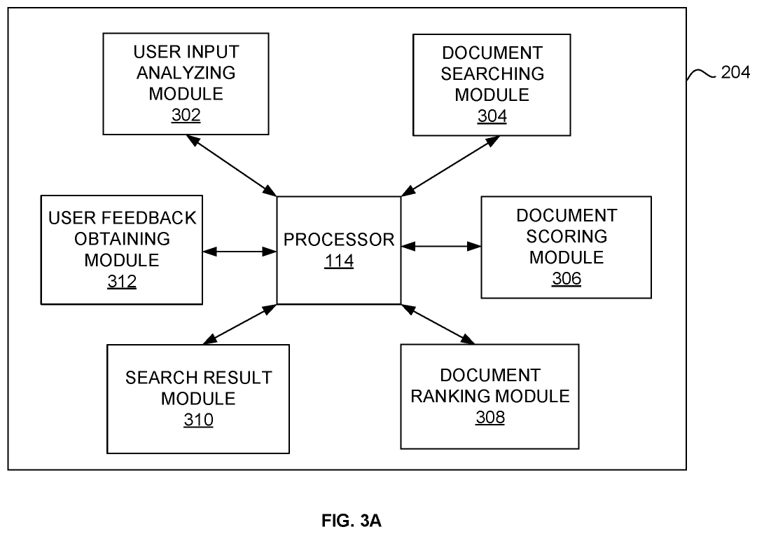

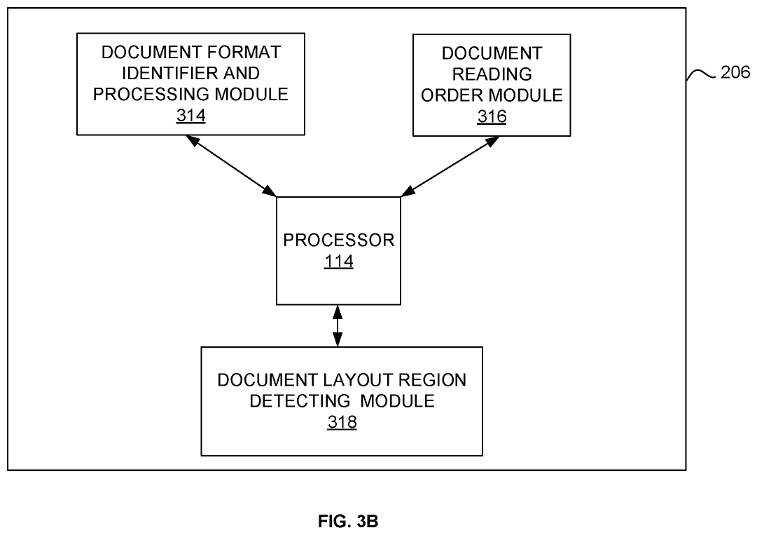

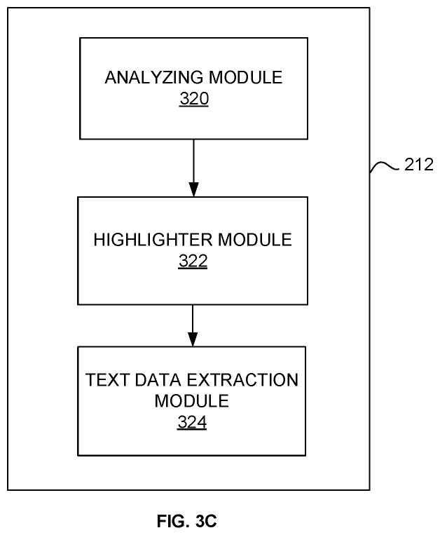

FIG. 3A is a block diagram of the search result obtaining module 204 of FIG. 2 according to some embodiments herein. The search result obtaining module 204 includes a user input analyzing module 302, a document searching module 304, a document scoring module 306, a document ranking module 308, a search result module 310, a user-feedback obtaining module 312, and the processor 114, to obtain the search result including the at least one document. The user input analyzing module 302 is configured to analyze the user input received from the user input receiving module 202. The user input includes at least one of the user data, the keywords, the specific context and the search terms. In some embodiments, the user input analyzing module 302 analyzes the user input to create a search query. For example, the user input can be “Prevalence of Hepatitis B infection in low- and middle-income countries”, where the system 102 creates the search query “(“hepatitis B” OR hepatitis B infection OR hepatitis B virus OR HBV OR HBsAG) AND (“epidemiology” OR incidence OR prevalence) AND (low income countries OR middle income countries OR LMIC)”. In some embodiments, the search query can be combined using a logical operator and expanded key phrases of the search query using MeSH (Medical Subject Holdings) controller vocabulary. In some embodiments, synonyms of the key phrases can be grouped with “OR” operator and combining other terms with “AND” operator. The MeSH may be a NLM controlled vocabulary thesaurus used for indexing the one or more documents in the database 116.

The document searching module 304 is configured to search and identify the at least one document in the database 116 by analyzing the search query, and display on the one or more user devices 104A-N using the user-interface module. The document scoring module 306 is configured to obtain document source, search results, document subsets, and user behaviors including click-through rate, recognize rate, rejection rate, reading rate, and additional rate of the one or more documents stored in the database 116, to generate a document score for the one or more documents. In some embodiments, the document recommendation algorithm generates the document score on the one or more documents stored in the database 116 by analyzing the user data, the search terms, and the document source.

The document ranking module 308 is configured to rank the one or more documents based on the document score. The search result module 310 is configured to provide the search result including the at least one document based on the ranking of the document score. In some embodiments, the AI model is configured to enable the document ranking module 308 and the search result module 310 to rank the one or more documents based on the document score and may recommend the at least one document based on the ranking. In some embodiments, the document recommendation algorithm includes a Vector Space Model (VSM) that generates the document score on the one or more documents. In some embodiments, the VSM is configured to represent the one or more documents as vectors in a vector space to score the one or more documents.

The user-feedback obtaining module 312 is configured to obtain user feedback from the user 106 using the one or more user devices 104A-N. The user feedback may include at least one of acceptation or rejection of the at least one document. The system 102 may enable the user 106 to at least one of accept or reject the at least one document in the search result, that enables re-generating the document score on the one or more documents in the database 116 using the document recommendation algorithm and re-ranking the one or more documents on the database 116 based on the document score using the AI model. In some embodiments, the document scoring module 306 and the document ranking module 308 modify the scoring and ranking of the one or more documents in the database 116 based on the user feedback. When the user 106 accepts or rejects the at least one document in the search result, the user-feedback may be converted into a signal to the continuous learning model. In some embodiments, the accept or reject actions can be encoded as I/O labels, which determines a prediction in obtaining the relevant document. The continuous learning model may be a statistical classification model. The continuous learning model may make use of textual features and uses embeddings trained on a biomedical corpus.

The document ranking module 308 may include an experimental dynamic model that re-ranks the one or more documents based on the user feedback. The experimental dynamic model may obtain the user data, the search terms and the document source as an input and re-rank the one or more documents based on the document score generated. In some embodiments, the document ranking module 308 includes a continuous learning model for re-ranking the one or more documents in the database 116 that updates on each user feedback.

In some embodiments, the document searching module 304 is configured to expand the search query for condensing the document recommendations. The AI model may input the extracted text from the subset of the document layout regions and contextual information based on the user input in the document searching module 304, and provide the extracted text and the contextual information as a query to the database 116 to obtain an updated search result including the at least one document. In some embodiments, the updated search result enables the document ranking module 308 to re-rank the one or more documents in the database 116 using the document recommendation algorithm. The contextual information may be a disease or drug, a subtopic that the user 106 is interested in, and the like. In some embodiments, the document searching module 304 uses an ontology for identifying the at least one context associated with the terms in the search query for expanding the search query. In some embodiments, the document searching module 304 uses SNOMED Clinical Terms (CT) for search query expansion, which is a systematically organized computer-processable collection of medical terms providing codes, terms, synonyms and definitions used in clinical documentation and reporting.

The processor 114 is communicatively connected with the user input analyzing module 302, the document searching module 304, the document scoring module 306, the document ranking module 308, the search result module 310, the user-feedback obtaining module 312, that identifies the at least one document from the database 116.

FIG. 3B is a block diagram of the document layout detection module 206 of FIG. 2 according to some embodiments herein. The document layout detection module 206 includes a document format identifier and processing module 314, a document reading order module 316, a document layout region detecting module 318, and the processor 114. The database 116 may include the one or more documents in various file formats including at least one of excel, pdf, word, csv, j son, xml, text file, and the like. The document format identifier and processing module 314 is configured to identify and process a format of the identified at least one document. In some embodiments, the document format identifier and processing module 314 identify and access the various document formats in the database 116.

The document reading order module 316 is configured to determine a reading order in the at least one document, and the document layout region detecting module 318 is configured to determine a layout in the at least one document, using the automated computer vision-based detection. The document layout detection module 206 includes a computer vision-based algorithm that processes different types of file formats of the one or more documents, removes noise, identifies any of sections, sub-sections, tables, and text along with the layout of the document, thereby resulting in a search on contents of the at least one document.

The document layout region detecting module 318 detects the document layout by (i) identifying each character from the at least one document from the search result, (ii) creating one or more words by analysing the identified characters, (iii) separating the one or more words with any of font style, font name and font size, (iv) illustrating a rectangle in a first colour for the one or more words in the document layout of a second colour in the text extracted from the subset of the document layout regions, (v) identifying at least one contour region by dilating the document layout of the second colour using at least one parameter, and (vi) forming the plurality of document layout regions by analysing the at least one identified contour region. The at least one parameter may include any of word spacing, word height, or font spacing of the extracted text. In some embodiments, after separating the one or more words, the document layout region detecting module 318 is configured to draw a black rectangle on each word per font style separately in a white layout. Some regions may overlap on the identified contour regions which may be merged.

The document reading order module 316 detects the reading order on the at least one document from the search result by computing both horizontal and vertical spaces, and selecting a separator when the horizontal and vertical spaces satisfy one or more conditions. The reading order may be determined using white spaces and both horizontal and vertical white spaces are computed. In some embodiments, the white spaces that satisfy the one or more conditions can be selected as the separator, to determine the reading order. In some embodiments, the document layout region detecting module 318 is configured to perform post-processing on the at least one document to remove header and footer, and determine headings of each block.

FIG. 3C is a block diagram of the text extracting module 212 of FIG. 2 according to some embodiments herein. The text extracting module 212 includes an analyzing module 320, a highlighter module 322, and a text data extraction module 324. The analyzing module 320 is configured to analyze the keywords and the specific context using the NLP technique. The text extracting module 212 may include a sentence-level recommendation algorithm that includes concepts with semantic search and key entities by the analyzing module 320.

The highlighter module 322 includes the NLP-based highlighter framework that extracts the at least one custom-named entity based on the at least one context on the subset of the document layout regions. The NLP-based highlighter framework may be a Named Entity Recognition (NER) model that extracts information as entities. The entities may be any word or series of words that consistently refers to the same thing. The NER model is configured to detect a named entity, and categorize and extract the named entity. The named entity includes the keywords and the specific context. The text data extraction module 324 is configured to extract the at least a part of the text from the at least one document with the analyzed keywords and the specific context based on research information.

The text extracting module 212 may use statistical model-based predictions and other known entity detection algorithms based on rule-based parsing, dictionary lookups, part-of-speech (POS) tagging, and/or dependency parsing. The NER model may be based on the model's current weight values. The weight values may be estimated based on data that the model has seen during training and may keep enhancing during the extraction. In some embodiments, the text extracting module 212 includes a distance supervision technique to generate more data samples and can be stored in the database 116.

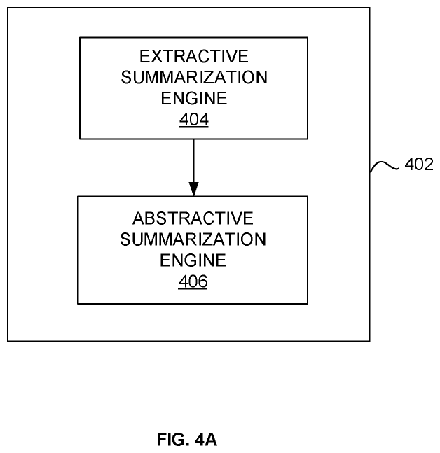

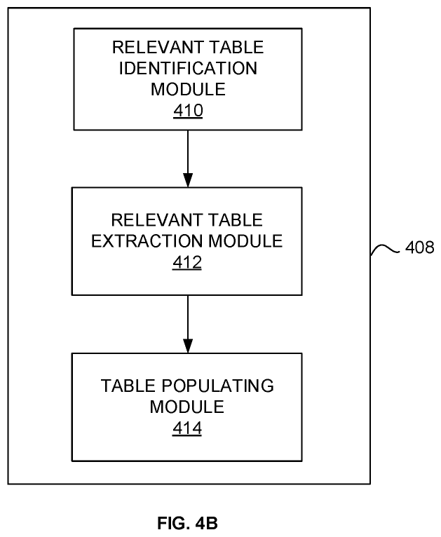

FIG. 4A is an exemplary block diagram of the system 102 of FIG. 1 to summarize the extracted text as a paragraph according to some embodiments herein. The system 102 includes a summarization module 402 that is configured to automatically summarize the part of the text extracted from the subset of the document layout regions into at least one summarized paragraph in the predetermined word limit without losing scientific context. In some embodiments, the predetermined word limit is in a range of 100 words to 200 words. The summarization module 402 may summarize the part of the text extracted from the subset of the document layout regions into the at least one summarized paragraph using one or more models. The one or more models includes at least one of extractive summarization engine, an abstractive summarization engine, data augmentation in the NLP technique, a Bayesian Additive Regression Tree (BART) model, or pre-trained encoder-decoder model for extractive and abstractive summarization. The summarization module 402 may include one or more models based on data augmentation in NLP (NLPAug), transformer encoder-encoder model and pre-trained encoder-decoder model for abstractive summarization (Pegaus).

The summarization module 402 is configured to combine multiple sentences from various literature sources and generate at least one summarized paragraph with a shorter word count without losing the scientific context. The summarization module 402 includes an extractive summarization engine 404, and an abstractive summarization engine 406, to automatically summarize into the at least one summarized paragraph. The system 102 may use Auto Tokenizers and encoders to reduce noise in the extracted data. In some embodiments, the summarization module 402 generates the at least one summarized paragraph by pre-processing and context-aware batching of the part of the extracted text.

The extractive summarization engine 404 is configured to obtain excerpts from shortlisted paragraphs and concatenate them together into shorter sentences. The data collected during extractive summarization, such as source text, and output text, may be collected and curated as golden summary datasets which may then be used to train a model which may provide scientific summaries. In some embodiments, the extractive summarization engine 404 checks for important sentences and includes the important sentences in the at least one summarized paragraph, that includes the exact part of the text from the at least one document. The extractive summarization engine 404 provides a recognition of key passages, evaluation of context, and deftly provides the at least one summarized paragraph.

The abstractive summarization engine 406 is configured to concatenate several sentences extracted exactly as in the at least one document being summarized, to produce abstractive summaries. The abstractive summaries may convey main information in the user input and may reuse phrases or clauses from the at least one document. In some embodiments, the abstractive summaries can be expressed in newly written language.

The system 102 may choose any of the extractive summarization engine 404 and the abstractive summarization engine 406 for generating the at least one summarized paragraph based on the section and context of the at least one document. In some embodiments, the user 106 has an option to make changes on the scientific report to keep the scientific context intact. The summarization module 402 may include one or more sets of transformer-based models, including the Bayesian Additive Regression Tree (BART) model that may be pre-trained by introducing random noise into original texts and reconstructing the original texts, to create the abstractive summaries.

FIG. 4B is an exemplary block diagram of the system 102 of FIG. 1 to extract at least one table according to some embodiments herein. The system 102 includes a table extraction module 408 that is configured to automatically identify and extract the at least one table from the subset of the document layout regions based on the at least one custom-named entity. In some embodiments, the table extraction module 408 is configured to automatically identify and extract the at least one relevant table from the at least one document using a table extraction algorithm. The table extraction module 408 includes a relevant table identification module 410, a relevant table extraction module 412, and a table populating module 414. The relevant table identification module 410 is configured to automatically identify the at least one relevant table from the subset of the document layout regions, based on the at least one custom-named entity using the table extraction algorithm. The table extraction algorithm may be configured to perform layout analysis on rich text format files containing tables to identify different parts of the table.

The relevant table extraction module 412 is configured to automatically extract the at least one relevant table from the at least one document using the table extraction algorithm. The extracted table may be post-processed that involves table merging and cleaning. The table populating module 414 is configured to populate the extracted relevant table under sections of the scientific report based on mapping. In some embodiments, the sections are identified based on a similarity between table titles and section titles to populate the extracted relevant tables under the sections of the scientific report. The table populating module 414 may populate the at least one summarized paragraph with the extracted at least one relevant table in at least one section of the scientific report.

In some embodiments, the table extraction module 408 is made with open-source tools for extracting Unicode text from document files using a custom rule-based system for identifying specific and relevant sets of tables. Templates to tables may be updated for supporting formats of the tables. In some embodiments, the table extraction module 408 generates the running text based on the at least one custom-named entity in the one or more tables of the subset of the document layout regions to extract at least one table by analysing titles, description, co-ordinates, and structure of the one or more tables, and populates the extracted at least one table in the scientific report using the NLP technique. The system 102 may enable the user 106 to insert the at least one table in a section of the scientific report.

In some embodiments, the table extraction module 408 includes a table detection model and a table structure recognition for extraction. The table detection model is the AI model that runs across all the pages of the at least one document, to identify the at least one table including table title, description, coordinates, and structure, of the at least one document. The table structure recognition for extraction is the AI model that creates a structure of the table using coordinates of the at least one identified table. The coordinates may be row, column, span cell, row header, and column header.

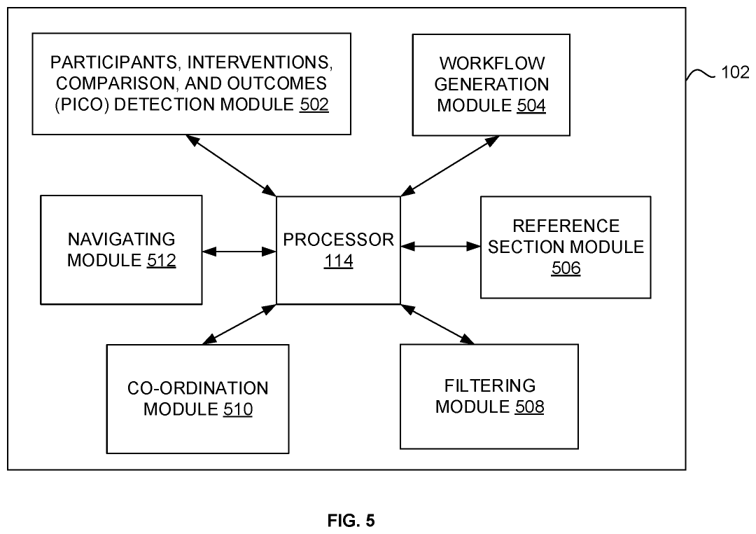

FIG. 5 is an exemplary block diagram of the system 102 of FIG. 1 according to some embodiments herein. The system 102 includes a Participants, Interventions, Comparison, and Outcomes (PICO) detection module 502, a workflow generation module 504, a reference section module 506, a filtering module 508, a co-ordination module 510, a navigating module 512, and the processor 114. The PICO detection module 502 is configured to identify Population, Interventions, Comparison, and Outcomes of the at least one document using a PICO detection model. The PICO detection model may be trained by Medical Information Mart for Intensive Care (MIMIC) dataset and the collected data, to identify the at least one document based on the user input accurately. In some embodiments, the collected data is the search result obtained in the search result obtaining module 204. In some embodiments, adversarial training and unsupervised pre-training can be performed on a bidirectional Long Short-Term Memory (LSTM) model to identify the PICO of the at least one document. In some embodiments, the PICO detection model can be validated against the PudMed PICO Element Detection Dataset.

The workflow generation module 504 is configured to generate a workflow based on the updation of the scientific report using a prisma workflow model, and automatically generate a visual representation of the generated workflow. The prisma workflow model may realign based on changes in the user input. The reference section module 506 is configured to automatically populate a reference section on the scientific report by analysing the updated scientific report, and automatically update the reference section when the scientific report is changed or updated based on the search result. The reference section module 506 may populate the reference section by analyzing different reference documents and different reference formats.

The filtering module 508 is configured to automatically filter the at least one document in the search result by identifying the at least one custom-named entity, the extracted text from the subset of the document layout regions, and the user behaviors in the at least one document. The filtering module 508 may update the AI model to rank the one or more documents in the database 116 based on the user data.

The co-ordination module 510 is configured to determine a location of the at least a part of the text extracted from the subset of the document layout regions in the updated scientific report. The location of the at least a part of the text includes x and y coordinates and page numbers of the at least one document. The location of the at least a part of the text from the at least one document may be stored in the database 116. In some embodiments, the co-ordination module 510 creates a hyperlink with the co-ordinates of the at least a part of the text.

The navigating module 512 is configured to navigate to the location of the at least a part of the text of the at least one document when the scientific report including the at least a part of the text from the at least one document is clicked, that enables the user 106 to cross validate the information in a faster manner.

The processor 114 is communicatively connected with the PICO detection module 502, the workflow generation module 504, the reference section module 506, the filtering module 508, the co-ordination module 510, and the navigating module 512. In some embodiments, the system 102 includes a collaborative editing module that enables one or more users to work on the scientific report at the same time in a collaborative manner in various quality checking stages. The collaborative editing module may provide tracked edits for user inputs, date and time of changes or modifications in real time. In some embodiments, the system 102 supports both single and multiple screens, that enables the user 106 to read, modify or make changes in one screen which reflects on the other.

In some embodiments, the system 102 includes a scientific report downloading module that enables the user 106 to download the generated scientific report in any of the docx format or the PDF format. The system 102 may generate the scientific report as a bibtex file. In some embodiments, the system 102 enables the user 106 to add highlights or notes, or articles on the scientific report.

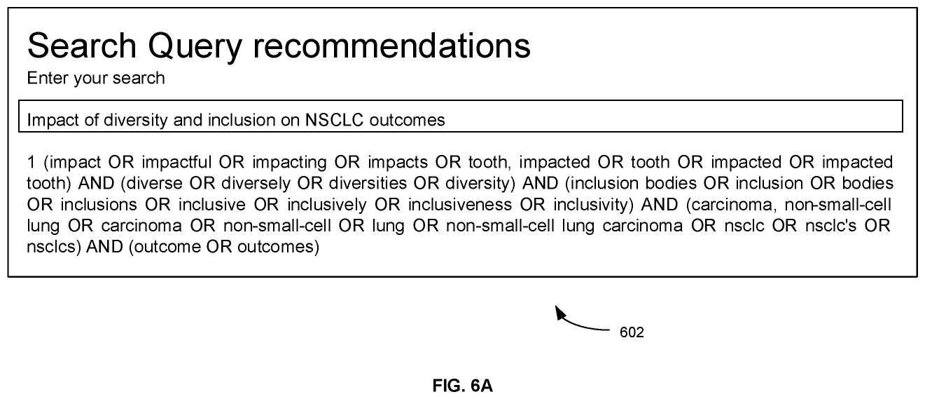

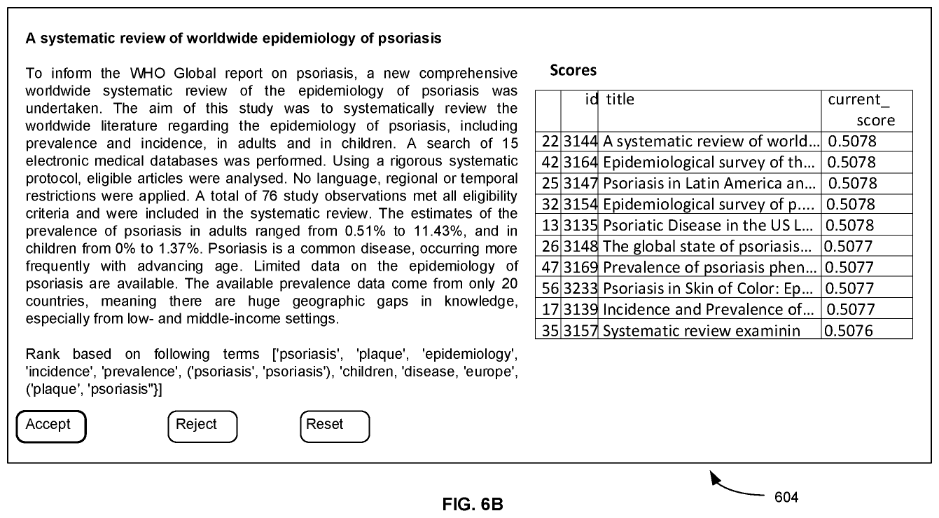

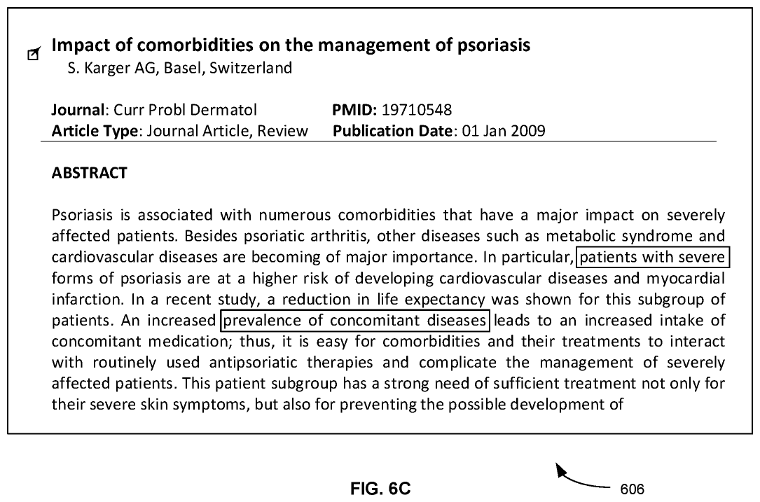

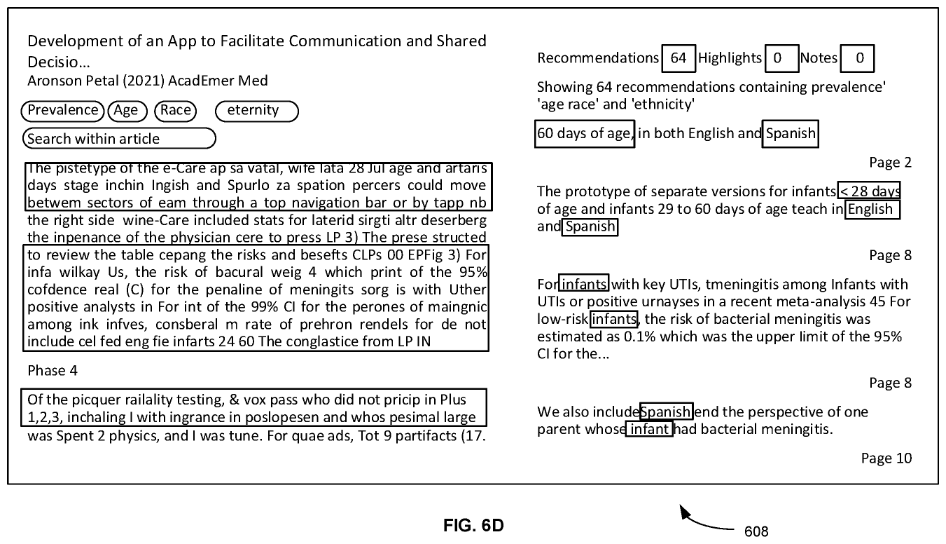

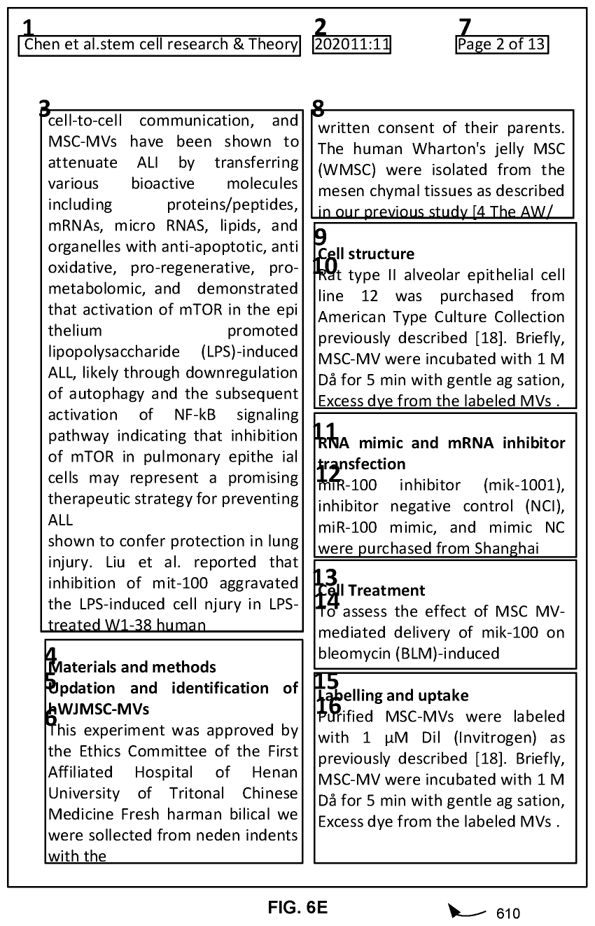

FIGS. 6A-6E illustrate exemplary user-interfaces of the system 102 according to some embodiments herein. FIG. 6A depicts a user interface 602 of search query recommendations for entering the user input. In some embodiments, the user input includes at least one of the user data, the keywords, the context and the search terms, which is the information required from the database 116. When the user input is provided on a search box, it displays the corresponding search query generated based on the user input.

FIG. 6B depicts a user interface 604 displaying at least one document and scores of the one or more documents identified based on the document score. The user interface 604 includes one or more options including an accept, a reject and a reset. Based on the information of the at least one document, the user 106 may choose any of the one or more options. If the user 106 chooses the accept option, the system 102 accepts the at least one document and re-ranks the at least one document based on the search query. If the user 106 chooses the reject option, the system 102 rejects the at least one document and re-ranks the at least one document based on the search query. If the user 106 chooses the reset option, the system 102 abandons the search and displays the user interface 602 for entering the user input. In some embodiments, re-ranking the one or more documents in the database 116 using the continuous learning model, which obtains article title, abstract, study information including objective, inclusion, and exclusion criterias, as features and labels are dynamically identified based on the user feedback.

FIG. 6C depicts a user interface 606 displaying the at least one context that is highlighted on the at least one document by performing the automated computer vision-based detection. FIG. 6D depicts a user interface 608 displaying the at least one custom-named entity that is highlighted on the at least one document by applying the NLP technique and the NER model. FIG. 6E depicts a user interface 610 displaying highlighted contents in the at least one document that extracts all the text blocks including header, footer, heading, and paragraphs. The text blocks may include properties including co-ordinates of each block, page number, text, font information and rotation information.

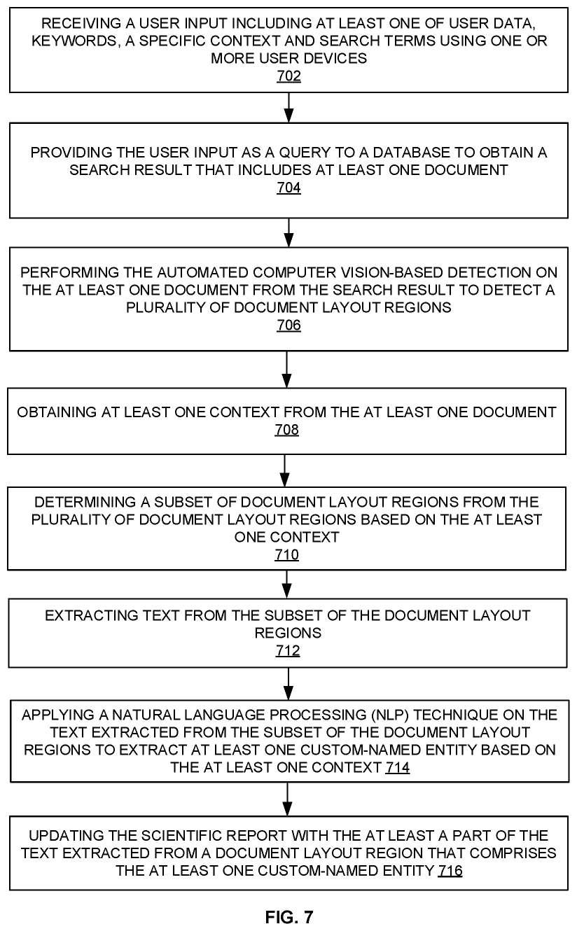

FIG. 7 is a flow diagram illustrating a method for generating the scientific report by extracting relevant content from search results according to some embodiments herein. At a step 702, a user input including at least one of the user data, the keywords, the context and the search terms is received using the one or more user devices 104A-N. At a step 704, the user input is provided as the query to the database 116 to obtain the search result including the at least one document. At a step 706, the automated computer vision-based detection is performed on the at least one document from the search result to detect the plurality of document layout regions.

At a step 708, the at least one context is obtained from the at least one document. At a step 710, the subset of document layout regions is determined from the plurality of document layout regions based on the at least one context. At a step 712, the text is extracted from the subset of the document layout regions. At a step 714, the Natural Language Processing (NLP) technique is applied on the text extracted from the subset of the document layout regions to extract at least one custom-named entity based on the at least one context. At a step 716, the scientific report is updated with the at least a part of the text extracted from the subset of the document layout regions that includes the at least one custom-named entity.

Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

The present subject matter described with reference to FIG. 1 to FIG. 7, should be noted that the description and figures merely illustrate the principles of the present subject matter, with enabling implementation examples. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

The system 102 is architected in a such way, that the researcher can perform intelligent searches using relevant keywords against public/enterprise document repositories. The results thus obtained are merged, deduplicated and automatically reranked using the AI models. The system 102 performs a quick extraction of text and tables that are of relevance from the shortlisted documents using the NLP/Table extractor. These results are presented to the user 106, who can quickly select the input data points, collate, paraphrase and summarize them using our NLG modules. In addition, the system 102 also provides a table detection, extraction and further generation of natural language summaries using our Computer Vision based Table Extraction and Language generation models. Data pertaining to the accuracy of all models is captured based on user actions and feedback which are used for retraining these models for better accuracy.

As described above, the present subject matter seeks to provide a time-efficient and error-free means for supporting literature screening, authoring, and finalization. Although the subject matter has been described in considerable detail with reference to certain examples and implementations thereof, other implementations are also possible. As such, the present disclosure should not be limited to the description of the preferred examples and implementations contained therein.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may existing in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

I/We claim:

1. A method for generating a scientific report by extracting relevant content from search results, the method comprising:
receiving, using one or more user devices, a user input comprising at least one of user data, keywords, a context and search terms;
providing the user input as a query to a database to obtain a search result that comprises at least one document;
performing an automated computer vision-based detection on the at least one document from the search result to detect a plurality of document layout regions;
obtaining at least one context from the at least one document;
determining a subset of document layout regions from the plurality of document layout regions based on the at least one context;
extracting text from the subset of the document layout regions;
applying a Natural Language Processing (NLP) technique on the text extracted from the subset of the document layout regions to extract at least one custom-named entity based on the at least one context; and
updating the scientific report with the at least a part of the text extracted from the subset of the document layout regions that comprises the at least one custom-named entity.

2. The method of claim 1, wherein the subset of document layout regions is determined from the plurality of document layout regions by detecting and annotating at least one structure of the at least one document using the automated computer vision-based detection combined with the NLP technique, wherein the at least one structure comprises a text retrieval, a text categorization, a content categorization, an image parsing, or a table detection.

3. The method of claim 1, wherein the text extracted from the subset of document layout regions identify meaning of the extracted text by obtaining contextual data or context data of the text, and a hierarchy of the text from the subset of document layout regions, wherein the contextual data or the context data comprises information about background of the at least one document surrounding the extracted text.

4. The method of claim 1, wherein the method comprises:
generating a running text based on the at least one custom-named entity in one or more tables of the subset of the document layout regions to extract at least one table by analysing titles, description, co-ordinates, and structure of the one or more tables; and
populating, using the NLP technique, the extracted at least one table in the scientific report.

5. The method of claim 1, wherein the method further comprises:
generating, using a document recommendation algorithm, a document score on the one or more documents stored in the database by analysing the user data, the search terms, document source, search results, subset of documents, and user behaviours comprising click-through rate, recognize rate, rejection rate, reading rate, and additional rate of the one or more documents stored in the database, wherein the document recommendation algorithm comprises a Vector Space Model (VSM) to generate the document score;
ranking, using an AI model, the one or more documents on the database (116) based on the document score; and
obtaining, using an AI model, the search result comprising the at least one document based on the ranking.

6. The method of claim 5, wherein the method comprises:
enabling, using the one or more user devices, a user to at least one of accept or reject the at least one document in the search result, that enables re-generating the document score on the one or more documents in the database using the document recommendation algorithm and re-ranking the one or more documents on the database based on the document score using the AI model.

7. The method of claim 6, wherein the method further comprises:
inputting, using the AI model, the extracted text from the subset of the document layout regions and contextual information based on the user input; and
providing the extracted text and contextual information as a query to the database to obtain a search result that comprises at least one document, that enables re-ranking of the one or more documents in the database using the document recommendation algorithm.

8. The method of claim 1, wherein the method further comprises:
determining a location of the at least a part of the text extracted from the subset of the document layout regions in the updated scientific report, wherein the location of the at least a part of the text comprises x and y coordinates and page numbers of the at least one document; and
navigating to the at least one document when the scientific report including the at least a part of the text from the at least one document is clicked.

9. The method of claim 1, wherein the method further comprises:
highlighting, using an NLP highlighter framework, the extracted at least one custom-named entity based on the at least one context on the subset of the document layout regions, wherein the NLP highlighter framework highlights the extracted at least one custom-named entity by analysing Rule-based parsing, Dictionary lookups, POS tagging, and Dependency parsing of the at least one custom-named entity.

10. The method of claim 9, wherein the NLP highlighter framework highlights the extracted at least one custom-named entity by analysing Rule-based parsing, Dictionary lookups, POS tagging, and Dependency parsing of the at least one custom-named entity.

11. The method of claim 1, wherein the method further comprises:
automatically populating a reference section on the scientific report by analysing the updated scientific report; and
automatically updating the reference section when the scientific report is changed or updated based on the search result.

12. The method of claim 1, wherein the at least one context and the at least one named entity comprises any of demographics including at least one of age group, gender, race, or ethnicity, wherein the at least one custom-named entity comprises severity, prevalence, incidence, country, medical conditions including at least one of unmet needs, or adverse events, intervention including at least one of treatments, therapies, or devices, and outcomes.

13. The method of claim 1, wherein the detection of the plurality of document layout regions using the automated computer vision-based detection comprises:
identifying each character from the at least one document from the search result;
creating one or more words by analysing the identified characters;
separating the one or more words with any of font style, font name and font size;
illustrating a rectangle in a first colour for the one or more words in a document layout of a second colour in the text extracted from the subset of the document layout regions;
identifying at least one contour region by dilating the document layout of the second colour using at least one parameter, wherein the at least one parameter comprises any of word spacing, word height, or font spacing; and
forming the plurality of document layout regions by analysing the at least one identified contour region.

14. The method of claim 1, wherein the method further comprises:
detecting, using the automated computer vision-based detection, a reading order on the at least one document from the search result by computing both horizontal and vertical spaces, and selecting a separator when the horizontal and vertical spaces satisfy one or more conditions.

15. The method of claim 1, wherein the method further comprises:
identifying Participants, Interventions, Comparison, and Outcomes (PICO) on the at least one document using a PICO detection model, wherein the PICO detection model is trained by Medical Information Mart for Intensive Care (MIMIC) dataset and collected data, thereby identifying the at least one document accurately.

16. The method of claim 1, wherein the method further comprises:
generating, using a prisma workflow model, a workflow based on the updation of the scientific report, wherein the prisma workflow model realigns based on changes in the user input; and
automatically generating a visual representation of the generated workflow.

17. The method of claim 1, wherein the method further comprises:
automatically filtering the at least one document in the search result by identifying the at least one custom-named entity, the extracted text from the subset of the document layout regions and user behaviours in the at least one document.

18. A system for generating a scientific report by extracting relevant content from search results, the system comprising:
a memory that store one or more instructions; and
a processor that executes the one or more instructions, wherein the processor is configured to:
receive, using one or more user devices, a user input comprising at least one of user data, keywords, a context and search terms;
provide the user input as a query to a database to obtain a search result that comprises at least one document;
perform an automated computer vision-based detection on the at least one document from the search result to detect a plurality of document layout regions;
obtain at least one context from the at least one document;
determine a subset of document layout regions from the plurality of document layout regions based on the at least one context;
extract text from the subset of the document layout regions;
apply a Natural Language Processing (NLP) technique on the text extracted from the subset of the document layout regions to extract at least one custom-named entity based on the at least one context; and
update the scientific report with the at least a part of the text extracted from the subset of the document layout regions that comprise the at least one custom-named entity.

19. One or more non-transitory computer-readable storage mediums storing one or more sequences of instructions, which when executed by one or more processors, causes to perform a method for generating a scientific report by extracting relevant content from search results, the method comprising:
receiving, using one or more user devices, a user input comprising at least one of user data, keywords, a context and search terms;
providing the user input as a query to a database to obtain a search result that comprises at least one document;
performing an automated computer vision-based detection on the at least one document from the search result to detect a plurality of document layout regions;
obtaining at least one context from the at least one document;
determining a subset of document layout regions from the plurality of document layout regions based on the at least one context;
extracting text from the subset of the document layout regions;
applying a Natural Language Processing (NLP) technique on the text extracted from the subset of the document layout regions to extract at least one custom-named entity based on the at least one context; and
updating the scientific report with the at least a part of the text extracted from the subset of the document layout regions that comprises the at least one custom-named entity.
